(19) United States
(12) Patent Application Publication
(10) Pub. No.: US 2017/0283680 A1
(43) Pub. Date: Oct. 5, 2017

(54) EMULSIFIERS FOR INVERT EMULSION WELLBORE FLUIDS AND METHODS OF USE THEREOF

(71) Applicant: M-I L.L.C., Houston, TX (US)

(72) Inventors: Yiyan Chen, Sugar Land, TX (US); Dimitri Khramov, Katy, TX (US)

(21) Appl. No.: 15/087,529

(22) Filed: Mar. 31, 2016

(51) Int. Cl. C09K 8/36

(52) U.S. Cl. CPC C09K 8/36

(57) ABSTRACT

A wellbore fluid may include an oleaginous external phase, a non-oleaginous internal phase and a reaction product of a capping agent with a base emulfisifer, the base emulsifier being a reaction product of a fatty acid and a hydrophilic compound having at least two reactive hydrophilic functional groups, the capping agent being selected from the group consisting of a polycarboxylic acid, anhydride, urea, isocyanate, alpha-halocarboxylic acid, oxirane, cyclic diester, and cyclic sulfonate ester.

### BACKGROUND

During the drilling of a wellbore, various fluids are typically used in the well for a variety of functions. The fluids may be circulated through a drill pipe and drill bit into the wellbore, and then may subsequently flow upward through wellbore to the surface. During this circulation, the drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the subterranean formation by providing sufficient hydrostatic pressure to prevent the ingress of formation fluids into the wellbore, to cool and lubricate the drill string and bit, and/or to maximize penetration rate.

### DETAILED DESCRIPTION

Embodiments disclosed herein are directed to compositions for stabilizing wellbore fluid formulations, including invert emulsion drilling and other wellbore treatment fluids. In another aspect, the present disclosure is directed to amide- and ester-based emulsifiers.

Emulsifiers in accordance with the present disclosure may be used to prepare emulsified wellbore fluids, including water-in-oil or invert emulsions in which an aqueous internal phase is stabilized by an emulsifier in an oil continuous phase. Emulsifiers may be relatively small molecules that often have a hydrophobic portion of the molecule that interacts with oleaginous fluids and a hydrophilic, often polar, portion of the molecule that interacts with aqueous fluids. When combined with a mixture of aqueous and oleaginous fluids, the emulsifier orients at the interface between the phases and forms a micelle. Depending on the balance between the hydrophobic and hydrophilic portions of the molecules, emulsifiers may form stronger barriers between the phases and more stable emulsions. Additionally, the emulsifiers of the present disclosure give better performance under low shear conditions and are able to stabilize higher internal phases.

Whether an emulsion of oil and water turns into a “water-in-oil” emulsion or an “oil-in-water” emulsion depends on a number of factors such as the volume fraction of both phases, the type(s) of surfactant present, temperature, and pH. For most emulsions, the Bancroft rule applies, which holds that surfactants tend to produce an internal phase from chemicals and solvents in which they are poorly soluble. The degree of emulsion for a mixed fluid may be tuned from complete emulsion to a metastable emulsion through the selection of the components of the wellbore fluid, particularly by selecting fluid components on the basis of hydrophilic/lipophilic balance (HLB).

HLB refers to the ratio of the hydrophilicity of a surfactant, due to the presence of polar groups, to the hydrophobicity of the surfactant due to lipophilic groups. HLB values may be calculated by considering the molecular weight contributions of the respective hydrophilic and lipophilic portions and taking the ratio thereof (divided by 5). A HLB value of 0 corresponds to a completely hydrophobic molecule, and a value of 20 corresponds to a completely hydrophilic molecule. Broadly, the HLB value may be used to estimate the emulsifying properties of a surfactant. Emulsifiers in accordance with the present disclosure may have an HLB value within the range of 0 to 10 in some embodiments, from 2 to 7 in other embodiments, and from 3 to 6.5 in still other embodiments.

In one or more embodiments, the emulsifiers of the present disclosure may be the reaction product of a capping agent with a base emulsifier formed from a reaction between a fatty acid with a hydrophilic compound (containing at least two hydrophilic groups such as amine, hydroxy groups, or combinations thereof) to form an amide- or ester-containing base emulsifier. The amide- or ester-containing base emulsifier may be reacted with capping agent to form an emulsifier of the present disclosure.

In one or more embodiments, the fatty acid may be any saturated or unsaturated (and optionally branched) fatty acid having a primary alkyl chain length with about 10 to about 70 carbon atoms therein. Given the range of 10 to 70 carbons, it is understood that reference to the term fatty acid includes both naturally occurring fatty acids and synthetic long chain carboxylic acids. In embodiments using naturally occurring fatty acids, the primary alkyl chain length may range from about 10 to 24; however, if branched, it is envisioned that the total carbon number may be greater than 24, with the C12-C24 primary alkyl chain optionally having one or more C1 to C24 branches. Further, it is also envisioned that the fatty acid may include dimer acids, trimer acids, oxidized polyethylene, etc.

As mentioned above, the fatty acid may be reacted with a hydrophilic compound, which may contain at least two (or at least three or four in more particular embodiments) reactive hydrophilic functional groups such as amines, hydroxyl groups and may contain other hydrophilic groups such as ethers, etc. In one or more embodiment, the hydrophilic compound may be an oligoalkylene amine, such as a having 1 to 5 repeating units of a C1 to C10 alkylene amine, or the corresponding oligoalkylene oxide or both at the same time, including polyetheramines, such as those sold under the trade name JEFFAMINE® (Hunstman Corporation). Example hydrophilic compounds may include diethylenetriamine (DETA), triethylenetetraamine (TETA), tetraethylenepentamine (TEPA), bis-hexamethylene triamine (BHMT), dipropylenetriamine, 1,3-propanediamine, 1,4-diaminobutane, 1,5-diaminopentane, N-(3-aminopropyl)-1,4-diaminobutane, aminoethanolethylenediamine (AEEA), etc. Thus, it is also envisioned that the oligoalkylene amine or oligoalkylene oxide may have one or more substituents off the primary oligo chain, including one or more functional groups.

As mentioned above, the fatty acid and the hydrophilic compound may first be reacted to form a base emulsifier, which is then subsequently reacted with a capping agent. In one or more embodiments, the fatty acid and hydrophilic compound may be reacted at various molar ratios, the effect of which may be differing base emulsifiers. The fatty acid may be present at least at a molar ratio of 1:1 (to form a hydrophobic tail and hydrophilic head), but may be 1.5:1, 2:1, 3:1, etc. The particular molar ratio may vary, for example, on the number of hydrophilic functional groups present on the compound; however, assuming that at least a portion of the hydrophilic functional groups are to be reacted with the capping agent, mentioned above and described in greater detail below, the molar ratio of the fatty acid to the hydrophilic compound will be less than the number of hydrophilic groups present in the hydrophilic compound. It is also understood that the base emulsifier may in fact be a mixture of base emulsifier compounds, depending on the location of the reaction (and molar ratio) between the fatty acid and hydrophilic compound. For example, for a reaction between oleic acid and diethylenetriamine, the following four base emulsifier products are feasible:

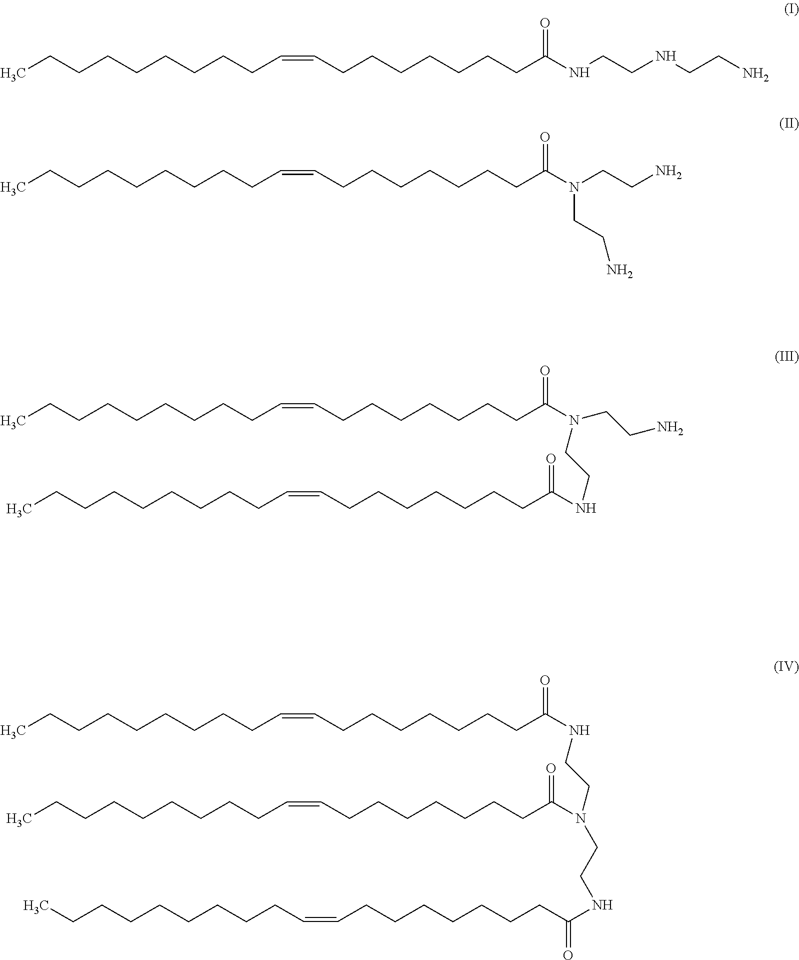 [SMILES: CCCCCCCCC/C=C\CCCCCCCC(=O)NCCNCCN ; CCCCCCCCC/C=C\CCCCCCCC(=O)N(CCN)CCN ; CCCCCCCCC/C=C\CCCCCCCC(=O)NCCN(CCN)C(=O)CCCCCCC/C=C\CCCCCCCCC ; CCCCCCCCC/C=C\CCCCCCCC(=O)NCCN(CCNC(=O)CCCCCCC/C=C\CCCCCCCCC)C(=O)CCCCCCC/C=C\CCCCCCCCC]

While it is described that it may be desirable for the molar ratio of the fatty acid and hydrophilic compound may be less than the total number of hydrophilic functional groups in order for the base emulsifier to react with a capping agent, it is understood that even with a molar ratio of 2:1 fatty acid to oligoamine, some quantity of the trimer (product (IV)) may result. Further, as described below, in some embodiments, such products may be used as emulsifier in accordance with the present disclosure.

As described above, emulsifiers of the present disclosure may include the reaction product of the base emulsifier with a capping agent capable of reacting with one or more of the remaining hydrophilic groups in the hydrophilic head of the base emulsifier. Such capping agents may include a polycarboxylic acid, anhydride (of a carboxylic acid such as acetic acid or a polycarboxylic acid), urea, isocyanates (such as methylisocyanate), alpha-halocarboxylic acid (such as chloroacetic acid, chloropropionic acid, etc.), oxirane, cyclic diesters (such as lactide or glycolide), or cyclic sulfonate ester (such as propanesultone or other sultones). Polycarboxylic acids may include, for example, lactic acid, glycolic acid and ether derivatives thereof, succinic acid, malonic acid, (ethylenedioxy) diacetic acid, maleic acid, oxalic acid, adipic acid, diglycollic acid, tartaric acid, tartronic acid, fumaric acid, citric acid, aconitic acid, citraconic acid, carboxymethyloxysuccinic acid, lactoxysuccinic acid, 2-oxy-1,1,3-propane tricarboxylic acid, oxydisuccinic acid, 1,1,2,2-ethane tetracarboxylic acid, 1,1,3,3-propane tetracarboxylic acid, 1,1,2,3-propane tetracarboxylic acid, cyclopentane-cis, cis, cis-tetracarboxylic acid, cyclopentadienide pentacarboxylic acid, 2,3,4,5-tetrahydrofuran-cis, cis, cis-tetracarboxylic acid, 2,5-tetrahydrofuran-cis-di carboxylic acid, 1,2,3,4,5,6-hexane-hexacarboxylic acid, mellitic acid, pyromellitic acid, phthalic acid, isophthalic acid, and terphthalic acid. Examples of the products (V)-(XVI) that may form between various capping agents and a base emulsifier are shown below:

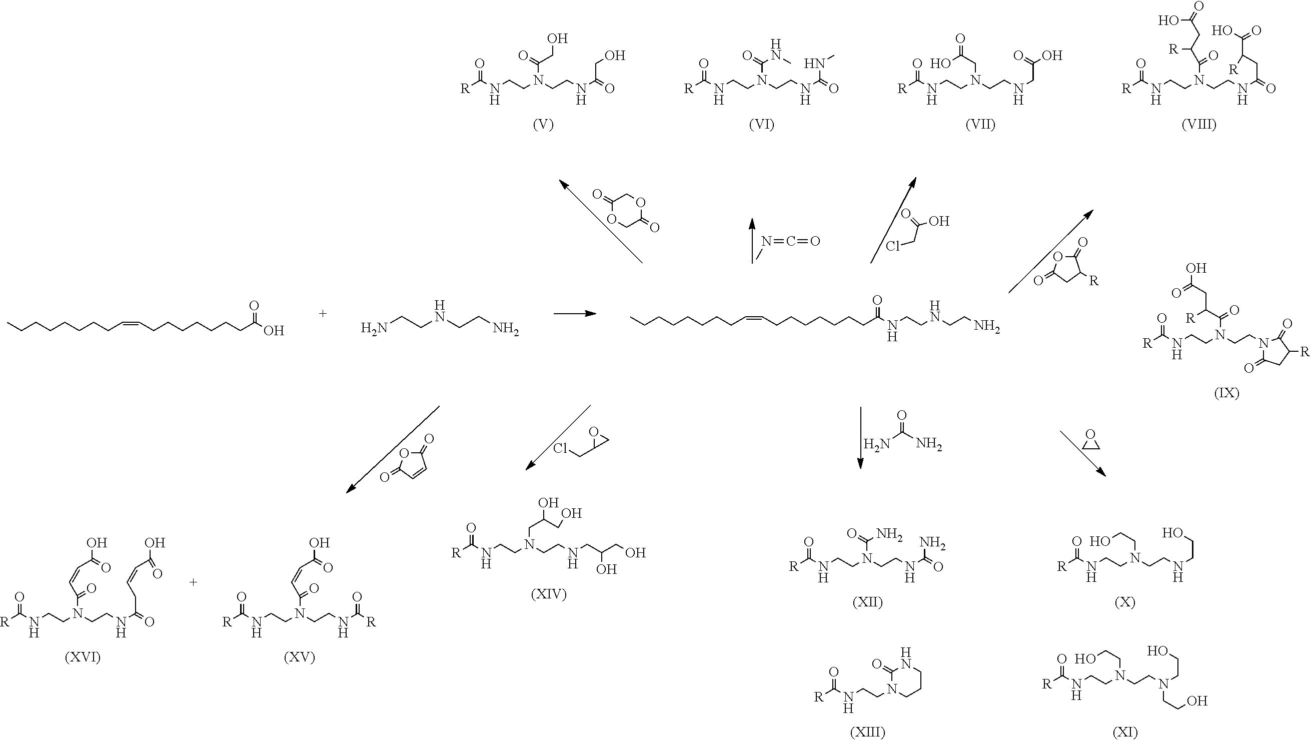

Further, as discussed above, the base emulsifier itself may vary (depending on the ratio of the fatty acid to hydrophilic compound, and location of condensation reaction), and as a result the location of the reaction between the capping agent and hydrophilic group may vary from what is shown in in the above reaction schemes. Indeed, the emulsifier of the present disclosure may include a mixture of products based on reaction with a mixture of base emulsifiers, such as discussed above. In addition to varying products produced from a mixture of base emulsifiers, it is also envisioned that in some embodiments, a capping agent having multiple reactive sites may react for each reactive site or upon reaction with the base emulsifier, a reactive site remains, allowing for intra- or inter-molecular reaction. For example, a cyclic anhydride may first react at a terminal amine to form product (VIII) and terminal acid group may react intramolecularly to form an imide, such as in product (IX) above, or product (XII) having two urea groups may react intramolecularly to form a cyclic urea group, such as in product (XIII). Other intramolecuar reactions are also envisioned. While not illustrated, the product (VIII) could react with additional base emulsifier to form a “dimer” (XV) (with R being the fatty chain from the fatty acid) as shown below.

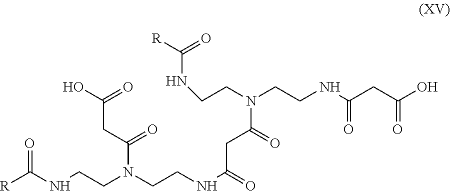

Further, it is also understood that even for the “dimerization”, any of the amine functionalities on the base emulsifier may be the location of the reaction with a second acidic group on the capping agent (from either the opening of a cyclic anhydride or from a polycarboxylic acid generally) from other intermolecular reactions, including Michael addition when such reactivity is possible for a capping agent such as maleic or fumaric acids. Further, while the capping agent reaction in each of the products shown above is at a location which had not been reacted with a fatty acid, the present disclosure is not limited, and it is envisioned for amine-based hydrophilic compounds, that the terminal amines may be reacted with both the fatty acid and capping agent.

The capping agent may be present in a molar ratio (relative to the hydrophilic compound) in an amount that is at least 0.5:1 (such as by forming a dimer with a linking capping agent) and that may vary (such as 1:1, 1.5:1, 2:1, 2.5:1, 3:1, etc.) depending on the number of reactive groups present on the hydrophilic compound. In one or more embodiments, the combined molar ratio of the fatty acid and capping agent to the reactive groups on the hydrophilic compound may be 1:1; however, it is also envisioned that not all reactive groups are reacted or that dimer, trimer, etc. species having a lower quantity of the capping agent are formed, indicating a lower than 1:1 molar ratio. In one or more embodiments, the emulsifier of the present disclosure may have at least 5 (or at least 6 in other embodiments) functional groups from the group of amides, esters, hydroxyl groups, imides, or ureas or combinations. Further, based on the number of hydrophilic groups present on the emulsifier, a fatty acid chain length may be selected to have the desired HLB for producing an invert emulsion.

While the above embodiment describes a reaction product formed between a fatty acid, hydrophilic compound and capping agent, it is also envisioned that in one or more other embodiments, emulsifiers of the present disclosure may be formed by reacting a fatty acid with a hydrophilic compound (containing at least two hydrophilic groups such as amine, hydroxy groups, or combinations thereof), where the fatty acid is reacted at a greater molar ratio than the hydrophilic compound to form multi-ester or multi-amide emulsifier, such as shown in products (III) and (IV) shown above. In such embodiments, the types of fatty acids and hydrophilic compounds may be as described above, and the molar ratio of the fatty acid to the hydrophilic compound may be at least 2:1, or at least 3:1, the upper limit of which may depend on the number of reactive hydrophilic groups present on the hydrophilic compound.

Above described reactions (including the reaction to form the base emulsifiers and capping reaction) may be performed in a base oil, such as the types of materials used as the external or continuous phase described below for the formulation into a wellbore fluid. The reaction conditions may include a temperature that is greater than the melting temperature of the reactants (or at least by 50° C. above the melting temperature in particular embodiments) and less than 300° C. in embodiments to avoid the degradation of the components/products. In particular embodiments, the conditions may be at least 100° C. under vacuum to drive off water formed from condensation reactions occurring between the reactants.

In particular embodiments, any of the above described emulsifiers of the present disclosure may be used in an amount ranging from 1 to 15 pounds per barrel, and from 2 to 10 pounds per barrel, in other particular embodiments. In some embodiments, wellbore fluids may contain an external oleaginous solvent component and an internal aqueous component having a ratio of the internal aqueous component to the external oleaginous component with the range of 30:70 to 95:5 in some embodiments, from 50:50 to 95:5 in some embodiments, and from 70:30 to 95:5 in yet other embodiments.

The oleaginous fluid may be a liquid and more preferably is a natural or synthetic oil and more preferably the oleaginous fluid is selected from the group including diesel oil; mineral oil; a synthetic oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids, mixtures thereof and similar compounds known to one of skill in the art; and mixtures thereof. In a particular embodiment, the fluids may be formulated using diesel oil or a synthetic oil as the external phase. The oleaginous fluid in one embodiment may include at least 5% by volume of a material selected from the group including esters, ethers, acetals, dialkylcarbonates, hydrocarbons, and combinations thereof.

The non-oleaginous fluid used in the formulation of the invert emulsion fluid disclosed herein is a liquid and preferably is an aqueous liquid. For example, the non-oleaginous liquid may be selected from the group including sea water, a brine containing organic and/or inorganic dissolved salts, liquids containing water-miscible organic compounds and combinations thereof. For example, the aqueous fluid may be formulated with mixtures of desired salts in fresh water. Such salts may include, but are not limited to alkali metal chlorides, hydroxides, or carboxylates, for example. In various embodiments of the drilling fluid disclosed herein, the brine may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium, salts of chlorides, bromides, carbonates, iodides, chlorates, bromates, formates, nitrates, oxides, phosphates, sulfates, silicates, and fluorides. Salts that may be incorporated in a given brine include any one or more of those present in natural seawater or any other organic or inorganic dissolved salts. Additionally, brines that may be used in the drilling fluids disclosed herein may be natural or synthetic, with synthetic brines tending to be much simpler in constitution. In one embodiment, the density of the drilling fluid may be controlled by increasing the salt concentration in the brine (up to saturation). In a particular embodiment, a brine may include halide or carboxylate salts of mono- or divalent cations of metals, such as cesium, potassium, calcium, zinc, and/or sodium.

Conventional methods can be used to prepare the drilling fluids disclosed herein in a manner analogous to those normally used, to prepare conventional oil-based drilling fluids. In one embodiment, a desired quantity of oleaginous fluid such as a base oil and a suitable amount of a surfactant are mixed together and the remaining components are added sequentially with continuous mixing. An invert emulsion may also be formed by vigorously agitating, mixing or shearing the oleaginous fluid and the non-oleaginous fluid.

In one or more embodiments, emulsifiers of the present disclosure may produce invert emulsions having increased stability to temperature and pressure aging, particularly when assayed using electrical stability (ES), for example. The ES test, specified by the American Petroleum Institute at API Recommended Practice 13B-2, Third Edition (February 1998), is often used to determine the stability of the emulsion. ES is determined by applying a voltage-ramped, sinusoidal electrical signal across a probe (consisting of a pair of parallel flat-plate electrodes) immersed in the mud. The resulting current remains low until a threshold voltage is reached, whereupon the current rises very rapidly. This threshold voltage is referred to as the ES (“the API ES”) of the mud and is defined as the voltage in peak volts-measured when the current reaches 61 μA. The test is performed by inserting the ES probe into a cup of 120° F. (48.9° C.) mud applying an increasing voltage (from 0 to 2000 volts) across an electrode gap in the probe. The higher the ES voltage measured for the fluid, the stronger or harder to break would be the emulsion created with the fluid, and the more stable the emulsion is. Thus, the present disclosure relates to invert emulsion fluids having an electrical stability of at least 50 V in an embodiment, and in the range of 50 V to 1000 V in some embodiments, and from 75 V to 900 V in other embodiments.

In addition to the emulsifying agent that stabilizes the oleaginous continuous phase and non-oleaginous discontinuous phase, the wellbore fluids may also include, for example, weighting agents. Other additives that may be included in the wellbore fluids disclosed herein include for example, wetting agents, organophilic clays, viscosifiers, fluid loss control agents, co-surfactants, dispersants, interfacial tension reducers, pH buffers, mutual solvents, thinners, thinning agents and cleaning agents.

In one or more embodiments, co-surfactants such as a large molecule such as fatty acid amide, alkyl urea, or a small molecule such as urea or alkyl/aryl carbonate, or a polymeric surfactant may be included.

Weighting agents or density materials (other than the inherent weight provided by the internal aqueous phase) suitable for use the fluids disclosed herein may include barite, galena, hematite, magnetite, iron oxides, illmenite, siderite, celestite, dolomite, calcite, and the like. The quantity of such material added, if any, depends upon the desired density of the final composition. Typically, weighting material may be added to result in a fluid density of up to about 24 pounds per gallon (but up to 21 pounds per gallon or up to 19 pounds per gallon in other particular embodiments). Additionally, it is also within the scope of the present disclosure that the fluid may also be weighted up using salts (such as in the non-oleaginous fluid (often aqueous fluid) discussed below). One having ordinary skill in the art would recognize that selection of a particular material may depend largely on the density of the material as typically, the lowest wellbore fluid viscosity at any particular density is obtained by using the highest density particles.

Wetting agents that may be suitable for use in the fluids disclosed herein include crude tall oil, oxidized crude tall oil, surfactants, organic phosphate esters, modified imidazolines and amidoamines, alkyl aromatic sulfates and sulfonates, fatty acid wetting agents and the like, and combinations or derivatives of these. FAZE-WET™, VERSACOAT™, SUREWET™, VERSA WET™, and VERSA WET™ NS are examples of commercially available wetting agents manufactured and distributed by M-I L.L.C. that may be used in the fluids disclosed herein. Silwet L-77, L-7001, L7605, and L-7622 are examples of commercially available surfactants and wetting agents manufactured and distributed by General Electric Company (Wilton, Conn.).

Conventional viscosifying agents that may be used in the fluids disclosed herein include organophilic clays, amine treated clays, oil soluble polymers, polyamide resins, polycarboxylic acids, and soaps, particularly during gravel packing by the alternate path technique (viscous fluid packing). The amount of viscosifier used in the composition can vary upon the end use of the composition. However, normally about 0.1% to 6% by weight range is sufficient for most applications. VG-69™ and VG-PLUS™ are organoclay materials distributed by M-I, L.L.C., Houston, Tex., and VERSA-HRP™ is a polyamide resin material manufactured and distributed by M-I, L.L.C., that may be used in the fluids disclosed herein. While such viscosifiers may be particularly useful during viscous fluid packing, they viscosifiers may also be incorporated into the fluid formulation for other completion operations as well.

Additionally, lime or other alkaline materials are typically added to conventional invert emulsion drilling fluids and muds to maintain a reserve alkalinity.

In one or more embodiments, Upon introducing a wellbore fluid of the present disclosure into a borehole, a filtercake may be formed which provides an effective sealing layer on the walls of the borehole preventing undesired invasion of fluid into the formation through which the borehole is drilled. Filter cakes formed from wellbore fluids disclosed herein include multiple latex polymers and may have unexpected properties. Such properties may include increased pressure blockage, reliability of blockage, and increased range of formation pore size that can be blocked. These filtercakes may provide filtration control across temperature ranges up to greater than 400° F.

Further, it is also envisioned that the wellbore fluids of the present disclosure may be injected into a work string, flow to bottom of the wellbore, and then out of the work string and into the annulus between the work string and the casing or wellbore. This batch of treatment is typically referred to as a “pill.” The pill may be pushed by injection of other wellbore fluids such as completion fluids behind the pill to a position within the wellbore which is immediately above a portion of the formation where fluid loss is suspected. Injection of fluids into the wellbore is then stopped, and fluid loss will then move the pill toward the fluid loss location. Positioning the pill in a manner such as this is often referred to as “spotting” the pill. Injection of such pills is often through coiled tubing or by a process known as “bullheading.”

Although the preceding description has been described herein with reference to particular means, materials, and embodiments, it is not intended to be limited to the particulars disclosed herein; rather, it extends to all functionally equivalent structures, methods, and uses, such as are within the scope of the appended claims. In addition, modifications of such means, materials, and embodiments are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words ‘means for’ together with an associated function.

What is claimed:

1. A wellbore fluid, comprising:
an oleaginous external phase;
a non-oleaginous internal phase; and
a reaction product of a capping agent with a base emulfisifer, the base emulsifier being a reaction product of a fatty acid and a hydrophilic compound having at least two reactive hydrophilic functional groups, the capping agent being selected from the group consisting of a polycarboxylic acid, anhydride, urea, isocyanate, alpha-halocarboxylic acid, oxirane, cyclic diester, and cyclic sulfonate ester.

2. The wellbore fluid of claim 1, wherein the fatty acid has a primary alkyl chain length of about 12 to 70 carbons.

3. The wellbore fluid of claim 1, wherein the reactive hydrophilic functional groups are selected from amines and hydroxyl groups.

4. The wellbore fluid of claim 3, wherein the hydrophilic compound is an oligoalkylene amine.

5. The wellbore fluid of claim 1, wherein a molar ratio of the fatty acid to the hydrophilic compound is at least 1:1 and less than the number of hydrophilic reactive functional groups.

6. The wellbore fluid of claim 1, wherein the capping agent is a polycarboxylic acid or anhydride thereof of lactic acid, glycolic acid and ether derivatives thereof, succinic acid, malonic acid, (ethylenedioxy) diacetic acid, maleic acid, oxalic acid, adipic acid, diglycollic acid, tartaric acid, tartronic acid, fumaric acid, citric acid, aconitic acid, citraconic acid, carboxymethyloxysuccinic acid, lactoxysuccinic acid, 2-oxy-1,1,3-propane tricarboxylic acid, oxydisuccinic acid, 1,1,2,2-ethane tetracarboxylic acid, 1,1,3,3-propane tetracarboxylic acid, 1,1,2,3-propane tetracarboxylic acid, cyclopentane-cis, cis, cis-tetracarboxylic acid, cyclopentadienide pentacarboxylic acid, 2,3,4,5-tetrahydrofuran-cis, cis, cis-tetracarboxylic acid, 2,5-tetrahydrofuran-cis-dicarboxylic acid, 1,2,3,4,5,6-hexane-hexacarboxylic acid, mellitic acid, pyromellitic acid, phthalic acid, isophthalic acid, or terphthalic acid.

7. The wellbore fluid of claim 1, wherein the reaction product of the capping agent and the base emulsifier has at least 5 hydrophilic groups selected from the group consisting of amides, esters, hydroxyl groups, imides, or ureas, or combinations thereof.

8. The wellbore fluid of claim 1, wherein the reaction product of the capping agent and the base emulsifier has a urea functional group contained therein.

9. The wellbore fluid of claim 1, wherein a molar ratio of the capping agent to the hydrophilic compound is at least 0.5:1 and less than the number of hydrophilic reactive functional groups.

10. A method, comprising:
injecting into a wellbore, a wellbore fluid comprising:
an oleaginous external phase;
a non-oleaginous internal phase; and
a reaction product of a capping agent with a base emulfisifer, the base emulsifier being a reaction product of a fatty acid and a hydrophilic compound having at least two reactive hydrophilic functional groups, the capping agent being selected from the group consisting of a polycarboxylic acid, anhydride, urea, isocyanate, alpha-halocarboxylic acid, oxirane, cyclic diester, and cyclic sulfonate ester.

11. The method of claim 10, wherein the fatty acid has a primary alkyl chain length of about 12 to 70 carbons.

12. The method of claim 10, wherein the reactive hydrophilic functional groups are selected from amines and hydroxyl groups.

13. The method of claim 12, wherein the hydrophilic compound is an oligoalkylene amine.

14. The method of claim 10, wherein a molar ratio of the fatty acid to the hydrophilic compound is at least 1:1 and less than the number of hydrophilic reactive functional groups.

15. The method of claim 10, wherein the capping agent is a polycarboxylic acid or anhydride thereof of lactic acid, glycolic acid and ether derivatives thereof, succinic acid, malonic acid, (ethylenedioxy) diacetic acid, maleic acid, oxalic acid, adipic acid, diglycollic acid, tartaric acid, tartronic acid, fumaric acid, citric acid, aconitic acid, citraconic acid, carboxymethyloxysuccinic acid, lactoxysuccinic acid, 2-oxy-1,1,3-propane tricarboxylic acid, oxydisuccinic acid, 1,1,2,2-ethane tetracarboxylic acid, 1,1,3,3-propane tetracarboxylic acid, 1,1,2,3-propane tetracarboxylic acid, cyclopentane-cis, cis, ci s-tetracarboxylic acid, cyclopentadienide pentacarboxylic acid, 2,3,4,5-tetrahydrofuran-cis, cis, cis-tetracarboxylic acid, 2,5-tetrahydrofuran-cis-di carboxylic acid, 1,2,3,4,5,6-hexane-hexacarboxylic acid, mellitic acid, pyromellitic acid, phthalic acid, isophthalic acid, or terphthalic acid.

16. The method of claim 10, wherein the reaction product of the capping agent and the base emulsifier has at least 5 hydrophilic groups selected from the group consisting of amides, esters, hydroxyl groups, imides, or ureas, or combinations thereof.

17. The method of claim 10, wherein the reaction product of the capping agent and the base emulsifier has a urea functional group contained therein.

18. The method of claim 10, wherein a molar ratio of the capping agent to the hydrophilic compound is at least 0.5:1 and less than the number of hydrophilic reactive functional groups.

19. A wellbore fluid, comprising:
an oleaginous external phase;
a non-oleaginous internal phase; and
a reaction product of a fatty acid and a hydrophilic compound having at least two reactive hydrophilic functional groups, the fatty acid and the hydrophilic compound being present at a molar ratio of at least 2:1.

20. The wellbore fluid of claim 19, wherein the fatty acid has a primary alkyl chain length of about 12 to 70 carbons.

21. The wellbore fluid of claim 19, wherein the reactive hydrophilic functional groups are selected from amines and hydroxyl groups.

22. The wellbore fluid of claim 21, wherein the hydrophilic compound is an oligoalkylene amine.
